(19) United States
(12) Patent Application Publication
(10) Pub. No.: US 2014/0251186 A1
(43) Pub. Date: Sep. 11, 2014

(54) FLY ASH ZINC OXIDE CEMENT

(71) Applicant: Jon Douglas Cross, Bozeman, MT (US)

(72) Inventor: Jon Douglas Cross, Bozeman, MT (US)

(73) Assignee: GEOMATRIX INC., Bozeman, MT (US)

(21) Appl. No.: 14/198,635

(22) Filed: Mar. 6, 2014

Related U.S. Application Data
(60) Provisional application No. 61/773,864, filed on Mar. 7, 2013.

(51) Int. Cl. C04B 7/24

(52) U.S. Cl. CPC C04B 7/243
USPC 106/709; 106/705

(57) ABSTRACT

The present description is directed to a cement or cementitious mixture that includes fly ash, zinc oxide and borate. Importantly, the cementitious mixture includes greater than 50% of fly ash by weight, or alternatively greater than 75% by weight of fly ash, or still further alternatively greater than 90% or 95% by weight of fly ash. Zinc oxide is incorporated in the cementitious mixture at levels of 2.5% and greater, or alternatively at the amounts of about 5 to 20% zinc oxide. Finally, a borate compound in needed for use as a set retarder.

This application claims the benefit of U.S. Provisional Patent Application Ser. No. 61/773,864, filed Mar. 7, 2013 and entitled FLY ASH ZINC OXIDE CEMENT, which is incorporated by reference herein in its entirety.

The field of the present invention is cementitious mixtures that are incorporated with aggregate and water to form durable concrete structures through the use of fly ash and zinc oxide.

### BACKGROUND

The predominant mixture that is used to form concrete in the United States and around the world is Portland cement, aggregate and water together with numerous additional additives that may be incorporated for very specific applications. The cementitious material in these concrete products is Portland cement. While Portland cement is now widely available, it requires substantial energy to form the Portland cement powder. Accordingly, the manufacturing process for Portland cement is not environmentally friendly.

Fly ash is likewise known for use as a cementitious material. Fly ash is typically used in mixtures with Portland cement. The use of fly ash is environmentally friendly as it uses an otherwise by-product of the combustion of coal for energy. Different types of fly ash are formed from the combustion of different types of coal, so there is a wide variety of fly ash by-product that is made. A drawback to fly ash cement is that it may have relatively slow strength gain and slow setting time when used alone as a cementitious material. This is one reason why it is often mixed with Portland cement to form a cementitious mixture.

A known additive to cementitious mixtures includes zinc products, primarily zinc oxide. However, zinc oxide is known to be a set retardant. Even the use of very small amounts of zinc oxide are known to those of skill in the art to cause severe delay to the hydration reaction of cement that prevents or slows the set reaction time of a concrete that includes the zinc-containing cementitious mixture.

### SUMMARY

It is an object of the present invention to pursue the benefit of using relatively high amounts of zinc oxide in cementitious materials in combination with the fly ash component of that cementitious material. The combination of fly ash and zinc oxide in a cementitious material and the incorporation of that cementitious material in a concrete mixture renders the resulting concrete to be very corrosion resistant and yet still easy to handle and manage during the mixing and pouring process.

In one example a cementitious mixture is used in a concrete mixture that further comprises aggregate and water. The cementitious mixture comprises at least 50% by weight of fly ash, at least 2.5% by weight of zinc oxide, and borate. Alternatively, the cementitious mixture may comprise at least 75% by weight of fly ash, or alternatively at least 90% or at least 95% by weight of fly ash. The cementitious mixture may also comprise about 5-20% by weight of zinc oxide. The fly ash may comprise Class C and/or Class F fly ash. The cementitious mixture may further comprise Portland cement.

In another example, an admixture for subsequent addition to cement to create a blended cementitious mixture has from about 1% to about 50% by weight of the admixture blended in. The admixture comprises about 5% to 95% by weight of fly ash, about 2.5% to 20% by weight of zinc oxide, and a borate.

In a still further example, a concrete that includes a cementitious mixture, aggregate and water includes the cementitious mixture comprising at least 50% by weight of fly ash, at least 2.5% by weight of zinc oxide and a borate. The aggregate may comprise at least 50% by weight of recycled glass or alternatively, substantially 100% of recycled glass. The cementitious mixture may also comprise 5-20% zinc oxide.

### DETAILED DESCRIPTION

The present description is directed to a cement or cementitious mixture that includes fly ash, zinc oxide and borate. Importantly, the cementitious mixture includes greater than 50% of fly ash by weight, or alternatively greater than 75% by weight of fly ash, or still further alternatively greater than 90% or 95% by weight of fly ash. Zinc oxide is incorporated in the cementitious mixture at levels of 2.5% and greater, or alternatively at the amounts of about 5 to 20% zinc oxide. Finally, a borate compound in needed for use as a set retarder.

The mixture of fly ash and zinc oxide is counter intuitive to the cement/concrete industry. Both fly ash and zinc oxide are recognized as set retarders when incorporated into, for instance, a Portland cement mixture. Surprisingly, it has been found that fly ash and substantial amounts of zinc oxide can be mixed together, alone or with a Portland cement, to form a workable and strong cementitious mixture that displays both early strength and sustained strength over time. In fact, a borate is required for use with the combination of fly ash and zinc oxide in a cementitious mixture in order to slow down the set time of reaction. The reasons for this anomaly is believed to be related to which reaction phase occurs first when water is added to the powder blend. Fly ash, zinc oxide, and borates can be blended in proportions alone and with Portland cement based concrete mixtures as an admixture so that set times ranging from 1 hour to 30 hours can be achieved. Alternatively set times can be achieved that range from 3 hours to 12 hours. And furthermore, set times ranging between 2 hours and 8 hours can be achieved.

In one example, of a 100% fly ash cement, a concrete mix design is comprised of, by volume, 54% glass, 38% fly ash and zinc oxide and the remaining 8% is occupied by water and set retarder. If a pigment is used in the mixture, the percentages of fly ash, zinc oxide, glass, and water will change according to the percentage of pigment being introduced. When natural stone aggregates are used in place of the glass aggregate, the percentage of fly ash usage may drop to 30% and the aggregate usage goes up to 62% with the water and set retarder percentages remaining at 8%. The material percentages presented above represent the middle of the usable operating range for combining these particular materials to create structural concrete that does not require any special mixing or consolidation effort.

Other 100% fly ash cement mix designs utilize different material proportioning methods and consequently require changes in the mixing and consolidating processes commonly used with structural grade concrete. These mixes include a zero slump concrete, meaning the material requires significant energy to consolidate into formwork and will not flow on their own. These mixtures are used to produce paving stones, concrete masonry units, pervious concrete, roller compacted concrete and any other use that requires high compressive strength but with a zero slump. The material percentages for a standard block mix are 72% aggregate, 24% fly ash and zinc oxide, and 4% water. Again, these percentages represent the middle of the usable operating percentages for combining these materials to produce a material that has the requisite plastic state properties, specifically, zero slumps and high aggregate volume.

Materials

The primary cementitious ingredient in examples of 100% fly ash cementitious mix designs is Class C fly ash, a by-product of burning pulverized coal to generate electricity. Typically, Class C fly ashes have higher calcium oxide content than Class F fly ashes, a by-product of burning a different type of coal, thus rendering many Class C fly ashes with self-cementing (hydraulic) properties. The chemical requirement as to whether a fly ash is Class F or Class C is based on the sum of 3 primary oxides, SiO₂, Al₂O₃, and FeO₃. If the sum is equal to, or greater than 70%, then it is usually classified as a Class F fly ash. The sum of these oxides needs to exceed 50% for the ash to be classified as a Class C fly ash. This certainly is not a scientific method for determining the classification of a particular fly ash, but it is a good indicator prior to completing strength activity index tests. Generally speaking, Class C fly ashes have CaO contents in excess of 15% and Class F ashes have CaO contents below 15%. A chemical analysis of an exemplary Class C fly ash reveals 32.37% SiO₂, 17.52% Al₂O₃, 5.34% Fe₂O₃, 2.02% SO₃, and 28.89% CaO. The balance of the makeup is comprised of other trace elements. This is only one analysis representing one month of fly ash production. The relative percentages for each compound listed above can vary some without having profound impacts on how the ash performs in a cement. It is important for the ash to have a relatively high CaO content (greater that 15%) for the ash to be activated with water only. In situations where the CaO content for a fly ash is lower that 15%, additional high alkaline activation liquids and or solids may be necessary to initiate the reaction. Concrete systems that require activation by high alkaline materials are referred to as geo-polymer concretes. Concrete systems that do not require high alkaline activation are referred to as hydraulic or hydration concretes.

A common method for activating geo-polymer concrete systems is to substitute all or part of the mixing water with a high alkaline solution, commonly consisting of sodium hydroxide and sodium silicate. The relative proportions of each of these activation liquids are dependent on the chemical composition of the fly ash, particularly the ratio of SiO₂ to Al₂O₃. Other non-liquid materials can be used to create the necessary alkaline environment to foster a geo-polymer reaction to proceed. Activation with powdered minerals is much more complicated but equally effective if the correct proportions and types of minerals are used. Geo-polymer alkaline activation systems are generally used with Class F fly ash as there is not the requisite CaO present to drive the hydraulic hydration reaction. There are situations were both a hydration and geo-polymer reactions occur sequentially or simultaneously.

Zinc oxide is an inorganic, odorless, amorphous, white or yellowish white powder. There are two main processes that yield zinc oxide. One, referred to as the French process, involves vaporizing metallic zinc and allowing the vapor to react with the oxygen in the air, forming zinc oxide. The second method, referred to as the American process, yields a less pure form of zinc oxide due to the source material being an ore. The majority of zinc oxide is produced using the French process. The zinc oxide of interest for the present examples can have particle sizes ranging from 10⁻⁶ to 10⁻⁹ meters and can be amorphous or crystalline in structure. The purity of the zinc oxide should be at least 95%. The ideal operating purity is 99.9%.

Powdered inorganic borates are used to retard the reaction that occurs when water is added to the fly ash/zinc oxide mixture. There are several forms of borates that work well for this purpose. The primary performance difference between the forms of borate is the ease of use.

Pulverized recycled container glass, natural sand and rock aggregate are three of the aggregate choices used for the concrete mix designs. The aggregate type, or gradation, becomes more important if the aggregate is absorptive, but generally the aggregate does not influence the overall reaction other than providing free water in excess of the aggregates saturated surface dry (SSD) condition. Saturated surface dry means that the aggregate has absorbed all the water it can and the surface of the aggregate is wet but does not contain excess moisture held in place by surface tension. Ideally the aggregate gradation necessary to produce structural grade concrete should substantially align with the industry specification outlined in ASTM C-33.

General Process

Before mixing starts, all of the materials needed for the mix design are measured by weight into separate containers. There are basically five materials that get combined to form the concrete. They are fly ash, zinc oxide, pulverized recycled glass, and/or natural stone, water, and a set retarder. These materials are combined and mixed following industry accepted procedures depending on batch size.

The addition of zinc oxide to a Class C or F fly ash binder in percentages ranging from 0.001 to 85% improves the performance of the resulting fly ash based concrete regardless of the aggregate type being used. The list below describes at least some of the improvements:
Mild set retardation (15 minutes) for select mix designs;
Improves the overall workability of the plastic mixture, much easier to trowel;
Does not appear to increase water demands significantly;
Extends the time period between initial and final set significantly;
Appears to accelerate the cure rate;
Appears to increase adhesion to various substrates;
Increases the compressive strength of the mixture considerably;
Reduces permeability of the solidified matrix;
Improves microbial resistance; and
Improves corrosion resistance.

In addition to the 100% fly ash cement mixes described above, many more mix designs can be completed with varying degrees of performance. All can be viable mixtures for different applications. It has been found that relatively large percentages of Class F ash can be activated effectively with a blend of Class C fly ash and zinc oxide. Additionally, ternary blends consisting of Portland cement, Class C fly ash, and zinc oxide are effective at activating relatively large percentages of Class F ash.

The aggregate for the blended cements and resulting concrete can be comprised of recycled container glass, natural stone and sand, synthetic stone and sand or any combinations of these materials. The exact ratio of aggregate to cementitious materials is dependent on the type of aggregate being used and the overall physical gradation of the aggregate. A blend of smaller aggregate particles generally requires more cementitious material for effective binding compared to what is required for aggregate with average larger particle sizes.

### Example Cementitious Mixtures

Class C Fly Ash Plus Zinc Oxide
Combinations Attempted

| Class C Fly Ash % | Zinc Oxide % |
|---|---|
| 100 | 0 |
| 98 | 2 |
| 90 | 10 |
| 85 | 15 |
| 80 | 20 |
| 60 | 40 |
| 50 | 50 |

The mixtures listed above have all been attempted and completed at least two times and in some instances in excess of 10 times.

The results of these mixtures revealed a couple of trends with respect to workability and strength gain. The measure of workability for these mixtures was how long it took for the mixture to solidify after water was introduced to the blend of fly ash and zinc oxide. As the percentage of zinc oxide was increased, the resultant set time decreased. The strength gain for mixtures with zinc is greater than for mixture without. One example is that a mixture with 20% zinc has a 7 hour compressive strength of 2500 psi; a mixture with only 2% zinc has 7 hour strength of 1860 psi. This equates to a 34% increase in strength. Subsequent tests conducted at five days for strength revealed that this relationship holds and actually improves over time. The percent increase in strength for a mixture with 20% zinc versus a mixture with 2% zinc is 37% at five days.

Smaller mixes with larger percentages of zinc oxide were completed, but after about 50% the cost effectiveness is believed to be unfavorable. The highest level of zinc oxide tried in a mixture with Class C fly ash is 85%. Strength data for these higher percent zinc mixtures is not available other than qualitative observations. Based on the rate at which these higher percentage (greater than 50%) zinc mixtures cure, it is possible that these mixtures can also be optimized for a specific use.

Ranges for mixtures containing Class C fly ash plus zinc oxide as the binder are provided in the table below.

Ranges for Mixtures Containing
Class C Fly Ash Plus Zinc Oxide

| Class C Ash | Zinc Oxide |
|---|---|
| 10 to 97.5 | 2.5 to 90 |
| 25 to 97.5 | 2.5 to 75 |
| 55 to 97.5 | 2.5 to 45 |
| 75 to 97.5 | 2.5 to 25 |
| 80 to 97 | 3.0 to 20 |
| 90 to 95 | 5.0 to 10 |
| 95 to 97.5 | 2.5 to 5 |

The other concrete components including water, borate, aggregate, and viscosity modifiers have no set ranges. Each of these ingredients is dosed specific to what is desired for plastic state performance. In other words, these ingredients improve the workability of the wet concrete. There is a minimum amount of water that is required; a good base point for the water would be around 5% by weight of active binder. Typically, the dosage range for the borate falls somewhere between a half of one percent and one and a half percent but depending on the intended outcome the dosage range can be increased or decreased within reason to achieve the desired results. The quality of the Class C fly ash also plays a significant role in determining the operating range for dosing the borate. Fly ash production does not undergo any quality control with respect to the reuse of the fly ash in this process. Thus the relative amounts of calcium oxide in the ash changes regularly from batch to batch of ash. This is the reason there is no fixed dosage ranges and why the ranges are fairly large in the table above. It is known that dosing a borate at percentages higher than 10% goes beyond a useful point. The aggregate for these mixtures can consist of granulated or pulverized glass, natural stone and sand, synthetic stone and sand or any combination of these materials. The ratio of aggregate to binder also has a large range in that the binder can be used without the aggregate and the aggregate can be bonded into block with very minimal binder if specific processes are followed.

Class C Fly Ash Plus Class F Fly Ash Plus Zinc Oxide
Combinations Attempted

| Class C Fly Ash % | Zinc Oxide % | Class F Fly Ash % |
|---|---|---|
| 60 | 20 | 20 |
| 50 | 25 | 25 |
| 40 | 30 | 30 |
| 20 | 40 | 40 |

The results from these mixes clearly indicate that Class C fly ash blended with zinc oxide is a very cost effective alkaline activator that can be batched with large percentages of Class F ash to create a hybrid cement matrix. This set of mixtures was different than the mixtures with only Class C ash and zinc in that as the zinc content increases the compressive strength decreases. For example, the mixture with 60% Class C fly ash, 20% zinc oxide, and 20% Class F fly ash had a two day compressive strength of 3575 psi. The mixture with 20% Class C fly ash, 40% zinc oxide, and 40% Class F fly ash had a 2 day compressive strength of 914 psi. This reduction in strength is large, however, it serves as a really good base point with respect to blending Class C fly ash, zinc oxide, and Class F fly ash. Basically the ratios completed are good boundary condition mixes. Further optimization is required but some good starting points have been established. Based on the qualitative observations, the boundary conditions can be expanded even further with some optimization work related to the relative percentages of Class C, Class F, and zinc oxide. Ranges for mixtures containing Class C fly ash, Class F fly ash, and zinc oxide as the binder are provided in the table below.

Ranges for Mixtures Containing
Class C Fly Ash, Class F Fly Ash, and Zinc Oxide

| Class C Ash | Class F Ash | Zinc Oxide |
|---|---|---|
| 0 to 97.5 | 0 to 97.5 | 2.5 to 90 |
| 5 to 92.5 | 5 to 92.5 | 2.5 to 75 |
| 25 to 72.5 | 25 to 72.5 | 2.5 to 45 |
| 40 to 57.5 | 40 to 57.5 | 2.5 to 25 |
| 45 to 52.5 | 45 to 52.5 | 3.0 to 20 |
| | | 5.0 to 10 |
| | | 2.5 to 5 |

The ranges for the other than concrete components including water, borate, aggregate and a viscosity modifier if desired, are the same as for just Class C ash and zinc oxide combinations. The reasons are the same in that these ingredients mainly influence plastic state properties such as slump and set time. More ranges for this combination of ashes and zinc is included, because if Class F ash can be activated relatively cheaply, many potential applications would be available.

A combination of fly ash (Classes C and/or F) and zinc oxide along with a borate can be blended and used as an admixture in other cementitious mixtures such as Portland cement to create an enhanced concrete. The reason for using the blended admixture would be to impart the intrinsic benefits of the constituent ingredients of the admixture into the base cementitious mixture. Some of these benefits will include increased strength, reduced heat of hydration, reduce permeability, and increased corrosions protection. The benefits of using this admixture in a Portland cement based concrete mixture extend beyond this short list, specific mix details need to be known before the full extent of the benefits can detailed. The admixture can be dosed in amounts ranging from 0.1% to 99% by weight of base cementitious material. The practical operating range from a cost and functionality perspective for the admixture is in the range 2% to 50%.

Class C Fly Ash, Class F Fly Ash,
Zinc Oxide and Portland Cement
Combinations Attempted

| Class C Fly | | Class F Fly | Type I/II |
|---|---|---|---|
| Ash % | Zinc Oxide % | Ash % | Portland % |
| 15 | 20 | 60 | 5 |

The purpose of this combination was to see if the percentage of Class F fly ash could be increased above 50% while being activated by with a blend of Class C fly ash, zinc oxide, and Portland cement. This mixture behaved like all the others listed above with respect workability. The compressive strength, 490 psi of this mix was measured at two days. This is very low but somewhat expected as previous work shows that the addition of Portland cement above 3% severely retards the cure rate of the matrix for up to 21 days. With more optimization work this ternary blend will be very effective and durable cement. Ranges for mixtures containing Class C fly ash, Class F fly ash, zinc oxide and Portland cement as the binder are provided in the table below.

Ranges for Mixtures Containing Class C Fly Ash, Class F
Fly Ash, Zinc Oxide and Portland Cement

| Class C Ash | Class F Ash | Portland | Zinc Oxide |
|---|---|---|---|
| 0 to 95 | 0 to 95 | 0 to 95 | 2.5 to 90 |
| 2.0 to 75 | 2.0 to 75 | 2.0 to 75 | 2.5 to 75 |
| 5 to 50 | 5 to 50 | 5 to 50 | 2.5 to 45 |
| 10 to 35 | 10 to 35 | 10 to 35 | 2.5 to 25 |
| 25 to 35 | 25 to 35 | 25 to 35 | 3.0 to 20 |
| | | | 5.0 to 10 |
| | | | 2.5 to 5 |

The ranges for the borate, aggregate and viscosity modifier are the same as they were in the previous two sections for the same reason stated above. The water content range for these mixtures (with Portland) is larger than the mixtures detailed in the previous two sections. The low point will be the same, 5%, but the upper end will be 60%, whereas mixtures without Portland have an upper limit of 40%.

Other embodiments of the present invention will be apparent to those skilled in the art from consideration of the specification. It is intended that the specification and Figures be considered as exemplary only, with a true scope and spirit of the invention being indicated by the following claims.

What is claimed is:

1. A cementitious mixture for use in a concrete mixture that further comprises aggregate and water,
the cementitious mixture comprising at least 50% by weight of fly ash, at least 2.5% by weight of zinc oxide, and a borate.

2. A cementitious mixture as described in claim 1, wherein the cementitious mixture comprises at least 75% by weight of fly ash.

3. A cementitious mixture as described in claim 1, wherein the cementitious mixture comprises at least 90% by weight of fly ash.

4. A cementitious mixture as described in claim 1, wherein the cementitious material comprises at least 95% by weigh of fly ash.

5. A cementitious mixture as described in claim 1, wherein the cementitious material comprises about 5-20% by weight of zinc oxide.

6. A cementitious mixture as described in claim 1, wherein the fly ash comprises Class C fly ash.

7. A cementitious mixture as described in claim 1, wherein the fly ash comprises Class F fly ash.

8. A cementitious mixture as described in claim 1, wherein the fly ash comprises both Class C fly ash and Class F fly ash.

9. A cementitious mixture as described in claim 1, wherein the cementitious mixture comprises Portland cement.

10. An admixture for subsequent addition to cement to create a blended cementitious mixture having from about 1% to about 50% by weight of the admixture blended in, the admixture comprising:
about 5% to 95% by weight of fly ash, about 2.5% to 20% by weight of zinc oxide, and a borate.

11. An admixture as described in claim 10, wherein the admixture comprises about 50% to 95% by weight of fly ash and about 5% to 20% by weight of zinc oxide.

12. An admixture as described in claim 10, wherein the admixture comprises about 75% to 95% by weight of fly ash and about 10% to 20% by weight of zinc oxide.

13. A concrete that includes a cementitious mixture, aggregate and water wherein the cementitious mixture comprises at least 50% by weight of fly ash, at least 2.5% by weight of zinc oxide and a borate.

14. A concrete as described in claim 13, wherein the aggregate comprises at least 50% by weight of recycled glass.

15. A concrete as described in claim 13, wherein the aggregate comprises substantially 100% of recycled glass.

16. A concrete as described in claim 13, wherein the cementitious mixture comprises 5-20% zinc oxide.
